(19) United States
(12) Patent Application Publication
(10) Pub. No.: US 2023/0113276 A1
(43) Pub. Date: Apr. 13, 2023

(54) LASER PROCESSING OF LITHIUM BATTERY WEB

(71) Applicant: Applied Materials, Inc., Santa Clara, CA (US)

(72) Inventors: Wei-Sheng LEI, San Jose, CA (US); Girish Kumar GOPALAKRISHNAN NAIR, San Jose, CA (US); Kent Qiujing ZHAO, San Francisco, CA (US); Daniel STOCK, Alzenau (DE); Tobias STOLLEY, Oberursel (DE); Thomas DEPPISCH, Aschaffenburg (DE); Jean DELMAS, Santa Clara, CA (US); Kenneth S. LEDFORD, San Jose, CA (US); Subramanya P. HERLE, Mountain View, CA (US); Kiran VACHHANI, Livermore, CA (US); Mahendran CHIDAMBARAM, Saratoga, CA (US); Roland TRASSL, Giessen (DE); Neil MORRISON, Darmstadt (DE); Frank SCHNAPPENBERGER, Johannesberg (DE); Kevin Laughton CUNNINGHAM, Belmont, CA (US); Stefan BANGERT, Steinau (DE); James CUSHING, Santa Clara, CA (US); Visweswaren SIVARAMAKRISHNAN, Cupertino, CA (US)

(21) Appl. No.: 17/946,716

(22) Filed: Sep. 16, 2022

Related U.S. Application Data
(60) Provisional application No. 63/255,055, filed on Oct. 13, 2021.

(51) Int. Cl. H01M 50/102

(52) U.S. Cl. CPC H01M 50/102; H01M 10/0525

(57) ABSTRACT

Methods and apparatuses for processing lithium batteries with a laser source having a wide process window, high efficiency, and low cost are provided. The laser source is adapted to achieve high average power and a high frequency of picosecond pulses. The laser source can produce a line-shaped beam either in a fixed position or in scanning mode. The system can be operated in a dry room or vacuum environment. The system can include a debris removal mechanism, for example, inert gas flow, to the processing site to remove debris produced during the patterning process.

### CROSS-REFERENCE TO RELATED APPLICATIONS

This application claims benefit to U.S. Prov. Appl. No. 63/255,055, filed on Oct. 13, 2021, which is herein incorporated by reference.

### BACKGROUND

### Field

Embodiments described herein generally relate to laser ablation-based edge cleaning and patterning of lithium thin films for energy storage devices.

### Description of the Related Art

Rechargeable electrochemical storage systems are increasing in importance for many fields of everyday life. High-capacity energy storage devices, such as lithium-ion (Li-ion) batteries and capacitors, are used in a growing number of applications, including portable electronics, medical, transportation, grid-connected large energy storage, renewable energy storage, and uninterruptible power supply (UPS). In each of these applications, the charge/discharge time and capacity of energy storage devices are fundamental parameters. In addition, the size, weight, and/or cost of such energy storage devices are also fundamental parameters. Further, low internal resistance is integral for high performance. The lower the resistance, the less restriction the energy storage device encounters in delivering electrical energy. For example, in the case of a battery, internal resistance affects performance by reducing the total amount of useful energy stored by the battery as well as the ability of the battery to deliver high current.

One method for manufacturing energy storage devices is roll-to-roll processing. An effective roll-to-roll deposition process not only provides a high deposition rate, but also provides a film surface, which lacks small-scale roughness, contains minimal defects, and is flat, for example, lacks large scale topography. In addition, an effective roll-to-roll deposition process also provides consistent deposition results or “repeatability”.

Thin film lithium energy storage devices typically employ a thin film of lithium deposited on or over a copper substrate or web. Current lithium deposition technology can lead to a transition zone at each edge of the lithium film in which the lithium film transitions from nominal thickness to zero (bare copper). This transition zone of unwanted lithium can cause internal resistance issues in the formed energy storage device. Currently available edge cleaning and patterning techniques include chemical and mechanical techniques for removing this unwanted lithium. However, these chemical and mechanical techniques often damage the underlying substrate and materials deposited thereon.

Therefore, there is a need for an improved apparatus and methods for edge cleaning and patterning of lithium thin films for energy storage devices.

### SUMMARY

Embodiments described herein generally relate to laser ablation-based edge cleaning and patterning of lithium thin films for energy storage devices.

In one aspect a method of producing an energy storage device is provided. The method includes transferring a flexible conductive substrate having a lithium metal film formed thereover. The method further includes patterning the lithium metal film with a picosecond-pulsed laser scribing process to remove portions of the lithium metal film exposing the underlying flexible conductive substrate without etching the flexible conductive substrate while transferring the flexible conductive substrate.

Embodiments may include one or more of the following. Patterning the lithium metal film with a picosecond-pulsed laser scribing process to remove portions of the lithium metal film exposing the underlying flexible conductive substrate includes removing lithium from a transition region adjacent to an edge of the flexible conductive substrate. Patterning the lithium metal film with a picosecond-pulsed laser scribing process includes using a pulsed infrared laser having a wavelength of about 1 micrometer with a laser pulse width of about 15 nanoseconds or less and a pulse rep rate frequency of about 100 kHz or greater. The laser pulse width is from about 1 picosecond to about 15 picoseconds and the pulse rep rate frequency is 50 MHz or greater. Transferring the flexible conductive substrate includes moving the flexible conductive substrate at a speed from about 0.1 meters/minute to about 50 meters/minute. Patterning the lithium metal film with the picosecond-pulsed laser scribing process includes a single-pass laser ablation process. The picosecond-pulsed laser produces a line-shaped laser beam. The line-shaped laser beam is produced by single axis galvo scanning or polygon scanning. The picosecond-pulsed laser produces a circular Gaussian laser spot produced by 2-axis galvo scanning or polygon scanning.

In another aspect, a laser patterning system for patterning an energy storage device is provided. The laser patterning system includes a laser patterning chamber defining a processing volume and for processing a flexible conductive substrate having a film stack formed thereon. The laser patterning chamber includes a plurality of transfer rollers positioned in the processing volume and for transferring the flexible conductive substrate. The laser patterning chamber further includes a laser source arrangement including one or more picosecond-pulsed lasers positioned to expose the film stack to a laser as the flexible conductive substrate is in contact with at least one of the transfer rollers.

Embodiments may include one or more of the following. The laser source arrangement comprises a first laser source positioned above the plurality of transfer rollers to process a first side of the flexible conductive substrate and a second laser source positioned below the plurality of transfer rollers to process a second side of the flexible conductive substrate. At least one of the first laser source and the second laser source is positioned to emit a laser beam that is perpendicular to a travel direction of the flexible conductive substrate. The plurality of transfer rollers comprises a first transfer roller positioned above a second transfer roller and the laser source arrangement comprises a first laser source positioned to process a first side of the flexible conductive substrate and a second laser source positioned process a second side of the flexible conductive substrate. At least one of the first laser source and the second laser source is positioned to emit a laser beam that is parallel to a travel direction of the flexible conductive substrate. The one or more picosecond-pulsed lasers are positioned to remove lithium from a transition region adjacent to an edge of the flexible conductive substrate. The one or more picosecond-pulsed lasers are positioned to form trenches parallel to and perpendicular to a width of the flexible conductive substrate to form patterned cells. The one or more picosecond-pulsed lasers produce a pulsed infrared laser having a wavelength of about 1 micrometer with a laser pulse width of about 15 nanoseconds or less and a pulse rep rate frequency of about 100 kHz or greater. The laser pulse width is from about 1 picosecond to about 15 picoseconds and the pulse rep rate frequency is 50 MHz or greater. The picosecond-pulsed laser produces a line-shaped laser beam. The line-shaped laser beam is produced by single axis galvo scanning or polygon scanning. The picosecond-pulsed laser produces a circular Gaussian laser spot produced by 2-axis galvo scanning or polygon scanning.

In another aspect, a non-transitory computer readable medium has stored thereon instructions, which, when executed by a processor, causes the process to perform operations of the above apparatus and/or method.

### BRIEF DESCRIPTION OF THE DRAWINGS

So that the manner in which the above recited features of the present disclosure can be understood in detail, a more particular description of the embodiments, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A illustrates a top plan view of a flexible layer stack prior to laser edge cleaning in accordance with one or more embodiments of the present disclosure.

FIG. 1B illustrates a cross-sectional side view of the flexible layer stack of FIG. 1A in accordance with one or more embodiments of the present disclosure.

FIG. 2A illustrates a top plan view of the flexible layer stack of FIG. 1A after laser edge cleaning in accordance with one or more embodiments of the present disclosure.

FIG. 2B illustrates a cross-sectional side view of the flexible layer stack of FIG. 2A in accordance with one or more embodiments of the present disclosure.

FIG. 3 illustrates a flow diagram of a process of laser edge cleaning in accordance with one or more embodiments of the present disclosure.

FIG. 4A illustrates a top plan view of a flexible layer stack prior to laser patterning in accordance with one or more embodiments of the present disclosure.

FIG. 4B illustrates a cross-sectional side view of the flexible layer stack of FIG. 4A in accordance with one or more embodiments of the present disclosure.

FIG. 5A illustrates a top plan view of the flexible layer stack of FIG. 4A after laser patterning in accordance with one or more embodiments of the present disclosure.

FIG. 5B illustrates a cross-sectional side view of the flexible layer stack of FIG. 5A in accordance with one or more embodiments of the present disclosure.

FIG. 6 illustrates a flow diagram of a process of laser patterning in accordance with one or more embodiments of the present disclosure.

FIG. 7 illustrates a schematic view of a roll-to-roll web coating system incorporating a laser processing chamber in accordance with one or more embodiments of the present disclosure.

FIG. 8A illustrates a schematic side view of a laser source arrangement in accordance with one or more embodiments of the present disclosure.

FIG. 8B illustrates a schematic side view of another laser source arrangement in accordance with one or more embodiments of the present disclosure.

FIG. 8C illustrates a schematic side view of yet another laser source arrangement in accordance with one or more embodiments of the present disclosure.

FIGS. 9A-9C illustrate schematic top views of various laser configurations for laser edge cleaning in accordance with one or more embodiments of the present disclosure.

FIG. 10A illustrates a schematic top view of one laser configuration for laser edge cleaning in accordance with one or more embodiments of the present disclosure.

FIG. 10B illustrates a schematic top view of another laser configuration for laser edge cleaning in accordance with one or more embodiments of the present disclosure.

FIG. 11A illustrates a schematic top view of one laser configuration for laser edge cleaning in accordance with one or more embodiments of the present disclosure.

FIG. 11B illustrates a schematic top view of another laser configuration for laser edge cleaning in accordance with one or more embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

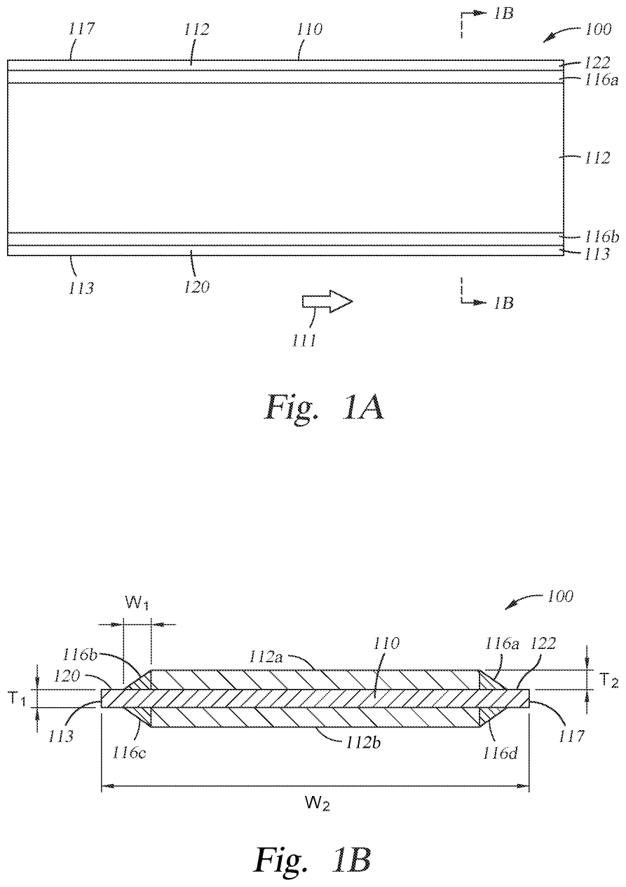

The following disclosure describes laser ablation-based edge cleaning and patterning in roll-to-roll deposition systems and methods for performing the same. Certain details are set forth in the following description and in FIGS. 1-11B to provide a thorough understanding of various embodiments of the disclosure. Other details describing well-known structures and systems often associated with laser-ablation, web coating, electrochemical cells, and secondary batteries are not set forth in the following disclosure to avoid unnecessarily obscuring the description of the various embodiments.

Many of the details, dimensions, angles and other features shown in the Figures are merely illustrative of particular embodiments. Accordingly, other embodiments can have other details, components, dimensions, angles and features without departing from the spirit or scope of the present disclosure. In addition, further embodiments of the disclosure can be practiced without several of the details described below.

Embodiments described herein will be described below in reference to a roll-to-roll coating system. The apparatus description described herein is illustrative and should not be construed or interpreted as limiting the scope of the embodiments described herein. It should also be understood that although described as a roll-to-roll process, the embodiments described herein can be performed on discrete substrates.

It is noted that while the particular substrate on which some embodiments described herein can be practiced is not limited, it is particularly beneficial to practice the embodiments on flexible substrates, including for example, web-based substrates, panels and discrete sheets. The substrate can also be in the form of a foil, a film, or a thin plate.

It is also noted here that a flexible substrate or web as used within the embodiments described herein can typically be characterized in that it is bendable. The term “web” can be synonymously used to the term “strip,” the term “flexible substrate,” or the term “flexible conductive substrate”. For example, the web as described in embodiments herein can be a foil.

It is further noted that in some embodiments where the substrate is a vertically oriented substrate, the vertically oriented substrate can be positioned or otherwise angled relative to a vertical plane. For example, in some embodiments, the substrate can be positioned at an angle in a range from about 1 degree to about 20 degrees from the vertical plane. In some embodiments where the substrate is a horizontally oriented substrate, the horizontally oriented substrate can be positioned or otherwise angled relative to a horizontal plane. For example, in some embodiments, the substrate can be positioned at an angle in a range from about 1 degree to about 20 degrees from the horizontal plane. As used herein, the term “vertical” is defined as a major surface or deposition surface of the flexible conductive substrate being perpendicular relative to the horizon. As used herein, the term “horizontal” is defined as a major surface or deposition surface of the flexible conductive substrate being parallel relative to the horizon.

It is further noted that in the present disclosure, a “roll” or a “roller” can be understood as a device, which provides a surface, with which a substrate (or a part of a substrate) can be in contact during the presence of the substrate in the processing system. At least a part of the “roll” or “roller” as referred to herein can include a circular-like shape for contacting the substrate to be processed or already processed. In some embodiments, the “roll” or “roller” can have a cylindrical or substantially cylindrical shape. The substantially cylindrical shape can be formed about a straight longitudinal axis or can be formed about a bent longitudinal axis. According to some embodiments, the “roll” or “roller” as described herein can be adapted for being in contact with a flexible substrate. For example, a “roll” or “roller” as referred to herein can be a guiding roller adapted to guide a substrate while the substrate is processed (such as during a deposition process) or while the substrate is present in a processing system; a spreader roller adapted for providing a defined tension for the substrate to be coated or patterned; a deflecting roller for deflecting the substrate according to a defined travelling path; a processing roller for supporting the substrate during processing, such as a process drum, e.g., a coating roller or a coating drum; an adjusting roller, a supply roll, a take-up roll or the like. The “roll” or “roller” as described herein can comprise a metal. In one or more embodiments, the surface of the roller device, which is to be in contact with the substrate can be adapted for the respective substrate to be coated.

Fabrication of thin film lithium batteries includes edge cleaning and web patterning to form cells by removing lithium formed on or over copper in designated areas of the web. Efficiently removing lithium and exposing underlying copper for either edge cleaning or web dividing/patterning presents several challenges. For example, any damage (e.g., engraving or scribing) to the underlying copper substrate/foil should be minimal. Moreover, any deformation or distortion of the underlying copper substrate should be minimal. The cleaning process should achieve a high level of cleanliness (e.g., a low level of lithium residue in the patterned areas). In addition, the cleaning process should be matched with the high speed of the moving web substrate. For example, production worthy moving speed of the web is typically from about 0.1 meters/minute to about 50 meters/minute. Thus, a single-pass laser ablation process can be preferable to a multi-pass process.

Thin film lithium batteries typically employ a thin film of lithium deposited on or over a copper substrate. Current lithium deposition technology generally leads to a transition zone having a width in a range from about 3 micrometers to about 10 micrometers at each side of the lithium film edge in which lithium film transitions from nominal thickness to zero (bare copper). This transition zone needs to be patterned to cleanly remove the lithium material. Another application is to remove lithium inside the web to form fine-width trenches along and perpendicular to the width of the web directions to form isolated cells. Currently available edge cleaning and patterning techniques include chemical and mechanical techniques for removing unwanted lithium. These chemical and mechanical methods often damage the underlying substrate and materials.

Embodiments of the present disclosure which can be combined with other embodiments include a system having a laser source for processing lithium batteries with a wide process window, high efficiency, and low cost. The laser source is adapted to achieve high average power and a high frequency of picosecond pulses. The laser source can produce a line-shaped beam either in a fixed position or in scanning mode. The system can be operated in a dry room or vacuum environment. The system can include a debris removal mechanism, for example, inert gas flow, to the processing site to remove debris produced during the patterning process.

FIG. 1A illustrates a top plan view of a flexible layer stack 100 prior to laser edge cleaning in accordance with one or more embodiments of the present disclosure. FIG. 1B illustrates a cross-sectional side view of the flexible layer stack 100 of FIG. 1A in accordance with one or more embodiments of the present disclosure. The flexible layer stack 100 can be formed by any suitable deposition process. The flexible layer stack 100 can be cleaned and patterned using the laser systems and methods described herein. The flexible layer stack 100 can be a lithium metal anode structure, for example, a lithium film formed on a copper substrate. The flexible layer stack 100 can be a lithiated or pre-lithiated anode structure. The flexible layer stack 100 shown in FIGS. 1A and 1B includes a flexible conductive substrate 110 or web having a lithium film or lithium film stack 112a, 112b (collectively 112) formed thereon. During processing, the flexible conductive substrate 110 is transported in a travel direction shown by arrow 111. In one or more embodiments which can be combined with other embodiments, the lithium film or lithium film stack 112 is a lithium metal film. In some embodiments which can be combined with other embodiments, the lithium film stack 112 includes a lithium metal film and additional films, for example, an anode film such as a graphite film with the lithium metal film formed thereon.

Current lithium metal deposition technologies form a transition zone 116a-116d (collectively 116) at each edge of the lithium film stack 112 in which the thickness of the lithium metal transitions from nominal thickness to zero where the surface of the flexible conductive substrate 110 is exposed (e.g., bare copper) along a near edge 113 and a far edge 117. The transition zone 116 can have a width “W₁”, for example, in a range from about 3 micrometers to about 10 micrometers. This transition zone 116 with non-uniform lithium thickness is patterned to cleanly remove the lithium material. The pattern of the lithium film stack 112 leaves an uncoated strip 120 of the flexible conductive substrate 110 exposed between the transition zone 116 and the near edge 113 of the flexible conductive substrate 110 and an uncoated strip 122 between the transition zone 116 and the far edge 117 of the flexible conductive substrate 110.

Each lithium film stack 112 includes a lithium film and optionally additional films. Although the lithium film stack 112 in FIGS. 1A-1B is shown as a single layer on each side of the flexible conductive substrate 110, it should be understood by those of ordinary skill in the art that the lithium film stack 112 can include a greater or smaller number of layers, which can be provided over, under and/or between the flexible conductive substrate 110 and the lithium metal film. Although shown as a double-sided structure, it should be understood by those of ordinary skill in the art that the flexible layer stack 100 can also be a single-sided structure with the flexible conductive substrate 110 and the lithium film stack 112.

In one or more embodiments, which can be combined with other embodiments, the flexible conductive substrate 110 comprises, consists of, or consists essentially of a metal, such as copper or nickel. Furthermore, the flexible conductive substrate 110 can include one or more sub-layers. Examples of metals that the current collectors can be or contain aluminum, copper, zinc, nickel, cobalt, tin, silicon, manganese, magnesium, alloys thereof, or any combination thereof. The web or flexible conductive substrate 110 can include a polymer material on which a current collector is subsequently formed, for example, a polymer material with a copper film formed thereon. The polymer material can be a resin film selected from a polypropylene film, a polyethylene terephthalate (PET) film, a polyphenylene sulfide (PPS) film, and a polyimide (PI) film. The substrate can be a flexible substrate or web, such as the flexible conductive substrate 110, which can be used in a roll-to-roll coating system.

According to some examples described herein, the flexible conductive substrate 110 can have a thickness “T1” equal to or less than about 25 μm, typically equal to or less than 20 μm, specifically equal to or less than 15 μm, and/or typically equal to or greater than 3 μm, specifically equal to or greater than 5 μm. In one or more examples, the flexible conductive substrate 110 has a thickness in a range from about 4.5 micrometers to about 10 micrometers. The flexible conductive substrate 110 can be thick enough to provide the intended function and can be thin enough to be flexible. Specifically, the flexible conductive substrate 110 can be as thin as possible so that the flexible conductive substrate 110 can still provide its intended function. The flexible conductive substrate 110 can have a width “W2” equal to or less than about 1200 millimeters, for example, from about 100 millimeters to about 1200 millimeters.

According to some examples described herein, the lithium film stack 112 can have a thickness “T2” of equal to or less than 20 μm, typically equal to or less than 8 μm, beneficially equal to or less than 7 μm, specifically equal to or less than 6 μm, in particular equal to or less than 5 μm. In one or more examples, the lithium film stack 112 has a thickness “T2” from about 1 μm to about 20 μm.

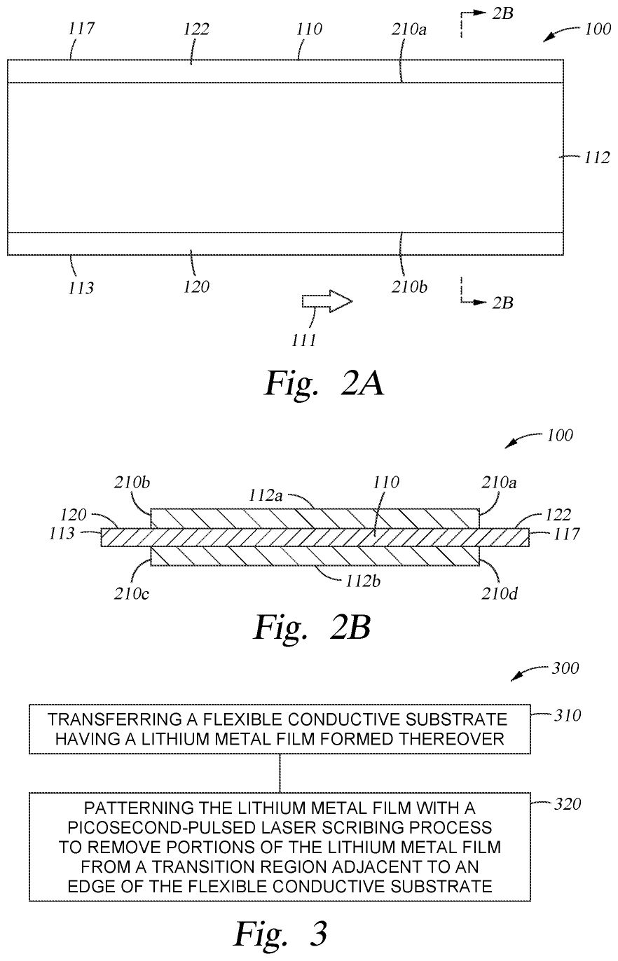

FIG. 2A illustrates a top plan view of the flexible layer stack 100 of FIG. 1A after laser edge cleaning in accordance with one or more embodiments of the present disclosure. FIG. 2B illustrates a cross-sectional side view of the flexible layer stack 100 of FIG. 2A in accordance with one or more embodiments of the present disclosure. As depicted in FIGS. 2A-2B, after laser edge cleaning of the flexible layer stack 100 according to one or more embodiments described herein, the transition zone 116 has been removed to expose edges 210a-210d (e.g., edges 210a. 210b, 210c, 210d) of the lithium film stack 112 and a surface of the flexible conductive substrate 110.

In one or more embodiments which can be combined with other embodiments, the flexible conductive substrate 110 is a copper substrate or a copper film formed on a flexible substrate and the lithium film stack 112 is a lithium metal film. In some embodiments which can be combined with other embodiments, the flexible conductive substrate 110 is a copper substrate and the lithium film stack 112 includes a graphite anode material, a silicon anode material, or a silicon-graphite anode material formed thereon and a lithium metal film formed on the anode material.

The flexible layer stack 100 shown in FIG. 1 can be, for example, a negative electrode of/for a secondary cell, such as a negative electrode or anode of/for a lithium battery. According to some examples described herein, a flexible negative electrode for a lithium battery includes the flexible conductive substrate 110 that can be a current collector including copper and having a thickness of equal to or less than 10 μm, typically equal to or less than 8 μm, beneficially equal to or less than 7 μm, specifically equal to or less than 6 μm, in particular equal to or less than 5 μm. The flexible layer stack 100 further includes a lithium film stack including lithium and having a thickness of equal to or greater than 5 μm and/or equal to or less than 15 μm.

FIG. 3 illustrates a flow diagram of a processing sequence 300 of laser edge cleaning in accordance with one or more embodiments of the present disclosure. The processing sequence 300 can be used to clean a transition region adjacent to the edge of a flexible conductive substrate, for example, the transition zone 116 of the flexible conductive substrate 110 shown in FIGS. 1A-1B. The processing sequence 300 can be performed using a laser patterning chamber, for example, the laser patterning chamber 720 depicted in FIG. 7. The laser patterning chamber 720 can be positioned in a coating system, such as the roll-to-roll web coating system 700 depicted in FIG. 7.

At operation 310, a flexible conductive having a lithium metal film formed thereover is transferred. In one or more embodiments which can be combined with other embodiments, transferring the flexible conductive substrate comprises moving the flexible conductive substrate at a speed from about 0.1 meters/minute to about 50 meters/minute.

At operation 320 during transfer of the flexible conductive substrate 110 the lithium metal film is patterned with a picosecond-pulsed laser scribing process to remove portions of the lithium metal film from a transition region adjacent to an edge of the flexible conductive substrate. In one or more embodiments which can be combined with other embodiments, patterning the lithium metal film includes using a laser having a pulse width in the picosecond range. Specifically a laser with a wavelength in the infrared (IR) range can be used to provide a picosecond-based laser, for example, a laser with a pulse width on the order of the picosecond (10-¹² seconds).

Laser parameters selection, such as pulse width, can be integral to developing a successful laser scribing and cleaning process that minimizes damage to the underlying substrate while achieving clean laser scribe cuts. The preference for a high frequency picosecond-pulsed IR laser can be justified from laser-material interaction mechanism specific to lithium/copper material stack. Lithium is very unique in that its melting temperature is only 453.65 K (180.50° C.) while the boiling temperature is 1603 K (1330° C.), which is still very high. The latent heat for melting and vaporization of lithium is 3 KJ/mol and 136 KJ/mol, respectively. In comparison, copper has a melting temperature 1357.77 K (1084.62° C.), and a boiling temperature 2835 K (2562° C.), with a latent heat for melting and vaporization of 13.3 KJ/mol and 300.4 KJ/mol, respectively. The optical properties of lithium are rarely available. Copper has a much lower absorption to IR laser than to green (˜520-540 ns) or UV laser (<360 nanometer). For example, at ambient temperature, a 1064 nanometer laser has less than 5% optical absorption in copper, while a 532 nanometer Green laser has about 40% optical absorption in copper. The 1064 nanometer laser in a melted copper liquid still has about 5% optical absorption. From the aspect of avoiding copper damage, the one um IR laser wavelength is more advantageous than a Green or UV laser wavelength. In addition, at the same average power level and with the same type of laser, an IR laser is more reliable and cost-effective. For lithium, while its optical properties are rarely known, from a debris management aspect, it is more advantageous to have an ultrashort pulsed laser to offer high enough laser intensity as to vaporize lithium rather than merely melt lithium for lithium ablation.

In one or more embodiments which can be combined with other embodiments, the ultrashort-pulsed laser scribing process with pulse width in the picosecond or femtosecond regime is performed using a diode pumped solid state (DPSS) pulsed laser source. In one or more embodiments which can be combined with other embodiments, the ultrashort-pulsed laser scribing process comprises using a picosecond-pulsed infrared laser source having a pulse width approximately equal to or less than 15 picoseconds, for example, in the range of 0.5 picosecond to 15 picoseconds, such as, in the range of 5 picoseconds to 10 picoseconds. In one or more embodiments which can be combined with other embodiments, the picosecond-pulsed laser source has a wavelength approximately in the range of about 1 micrometer, for example, from about 1030 nanometers to about 1064 nanometers (e.g., 1030 nm, 1057 um, 1064 nm, etc.). In one or more embodiments which can be combined with other embodiments, the laser source and corresponding optical system provide a focal spot at the work surface approximately in the range from about 5 microns to about 100 microns, for example, approximately in the range from about 20 microns to about 50 microns.

The spatial beam profile at the work surface may be circular shaped (including but not limited to a single mode (Gaussian)), or line-shaped, or rectangular shaped (including square shaped). In one or more embodiments which can be combined with other embodiments, the laser source has a pulse repetition rate of approximately 50 MHz or greater, for example, in the range of 50 MHz to 1,500 MHz (=1.5 GHz), such as approximately in the range of 500 MHz to 1,000 MHz (=1 GHz). In one or more embodiments which can be combined with other embodiments, the laser source delivers pulse energy at the work surface approximately in the range from about 0.05 μJ (=50 nJ) to about 100 μJ, such as approximately in the range from about 0.1 μJ (=100 nJ) to about 5 μJ. In one or more embodiments which can be combined with other embodiments, the laser source is operated at an average power of about 200 watts or greater, for example, in the range from about 200 watts to about 500 watts, such as in the range from about 300 watts to about 400 watts.

The laser patterning process can be run in a single pass only, or in multiple passes. However, due to the moving speed of the flexible conductive substrate, it is preferable that the laser patterning process be performed in a single pass. In one or more embodiments which can be combined with other embodiments, the scribing depth in the patterned film is approximately in the range from about 5 microns to about 50 microns deep, such as approximately in the range from about 10 microns to about 20 microns deep. The laser can be applied either in a train of single pulses at a given pulse repetition rate or a train of pulse bursts. In one or more embodiments which can be combined with other embodiments, the duration of a pulse burst is approximately in the range from about 5 nanoseconds to about 200 nanoseconds, such as in the range from about 20 nanoseconds to about 100 nanoseconds. The corresponding frequency of the pulse bursts is approximately in the range from 10 kHz to 500 MHz, such as in the range from 100 kHz to 1,000 kHz (=1 MHz). In one or more embodiments which can be combined with other embodiments, the laser beam generated kerf width is approximately in the range from about 10 microns to about 100 microns, for example, in the range from about 20 microns to about 50 microns.

In one or more embodiments which can be combined with other embodiments, the operation mode of the high pulse frequency pico-second laser (e.g., 1 GHz) is the train of pulse bursts. For example, for a 1 GHz pulsed laser, pulse-to-pulse separation (or duration) is 1 nanosecond. When 20 pulses of 1 GHz frequency are grouped into 1 pulse burst, the duration of such a burst is 20 nanoseconds. Compared to a single pulse of 20 nanosecond pulse width, a 20 nanosecond long train of pulse burst provides a different ablation mechanism and ablates materials more efficiently. In this mode of pulse bursts, the frequency of bursts (the separation of burst to burst) can also be manipulated.

Laser parameters can be selected with benefits and advantages such as providing sufficiently high laser intensity to achieve removal of lithium and to minimize damage to the underlying copper substrate. Also, parameters can be selected to provide meaningful process throughput for industrial applications with precisely controlled ablation width (e.g., kerf width) and depth. As described above, a picosecond-based laser is far more suitable to providing such advantages, as compared with femtosecond-based and nanosecond-based laser ablation processes. However, even in the spectrum of picosecond-based laser ablation, certain wavelengths may provide better performance than others. For example, In one or more embodiments, a picosecond-based laser process having a wavelength closer to or in the IR range provides a cleaner ablation process than a picosecond-based laser process having a wavelength closer to or in the UV range. In a specific such embodiment, a femtosecond-based laser process suitable for semiconductor wafer or substrate scribing is based on a laser having a wavelength of approximately greater than or equal to one micrometer. In a particular such embodiment, pulses of approximately less than or equal to 15,000 picoseconds of the laser having the wavelength of approximately greater than or equal to one micrometer are used. However, in an alternative embodiment, dual laser wavelengths (e.g., a combination of an IR laser and a UV laser) can be used.

In one or more embodiments which can be combined with other embodiments, a picosecond-pulsed laser scribing process includes using a pulsed infrared laser having a wavelength of about 1 micrometer, for example, in a range from about 1,030 nanometers to about 1,064 nanometers (e.g., 1,030 nm, 1,057 nm, or 1,064 nm) with a laser pulse width of about 15 nanoseconds or less and a pulse rep rate frequency of about 100 kHz or greater. In one or more examples, the laser pulse width from about 1 picosecond to about 15 picoseconds and the (seed) pulse rep rate frequency is about 50 MHz or greater to enable the laser to be operated with burst of pulses, and average power of about 200 watts or greater is used. In one or more embodiments which can be combined with other embodiments, to enable a large process widow, a scalable process throughput and at a lower cost, the picosecond IR laser has a seed pulse frequency of about 250 MHz to about 1.5 GHz, for example, about 500 MHz, capable of “burst of pulses” operation and an average power of about 400 watts or greater. In one or more embodiments which can be combined with other embodiments, and the laser source is able to generate a line-shaped laser beam for laser ablation. The line-shaped beam can be reconfigured into a circular Gaussian laser spot. Within the burst of pulses, the number of pulses can range from 1 to 100. It should be understood that a femtosecond IR laser, or a green or UV wavelength femtosecond or picosecond laser is also able to perform the processes described herein. However, these lasers either have a narrower process window or lower process throughput due to less available average power and at a higher laser source cost.

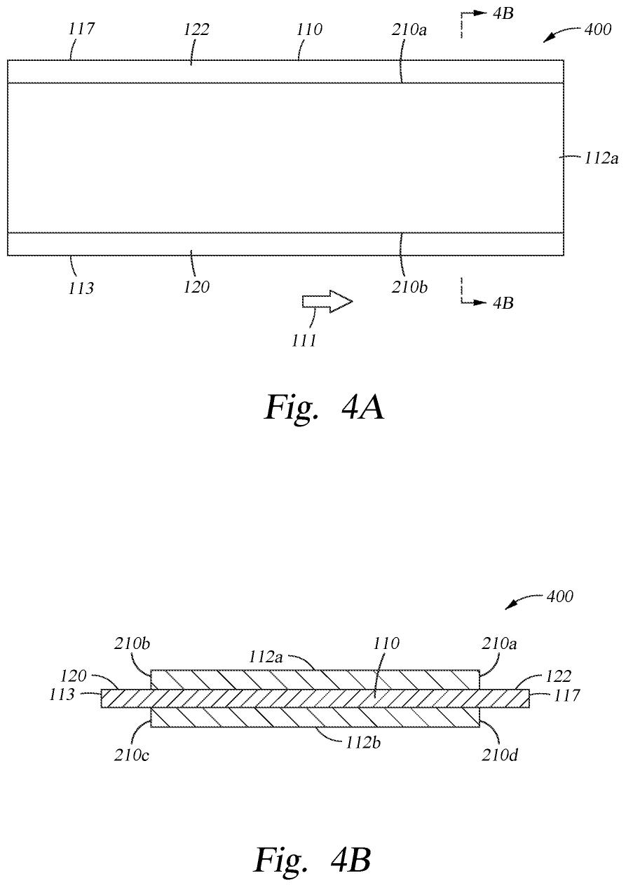

FIG. 4A illustrates a top plan view of a flexible layer stack 400 prior to laser patterning in accordance with one or more embodiments of the present disclosure. FIG. 4B illustrates a cross-sectional side view of the flexible layer stack 400 of FIG. 4A in accordance with one or more embodiments of the present disclosure. The flexible layer stack 400 can be similar to the flexible layer stack 100 depicted in FIGS. 2A-2B. The flexible layer stack 400 can be exposed to the edge cleaning process of processing sequence 300 prior to, during, or after the laser patterning process of processing sequence 600.

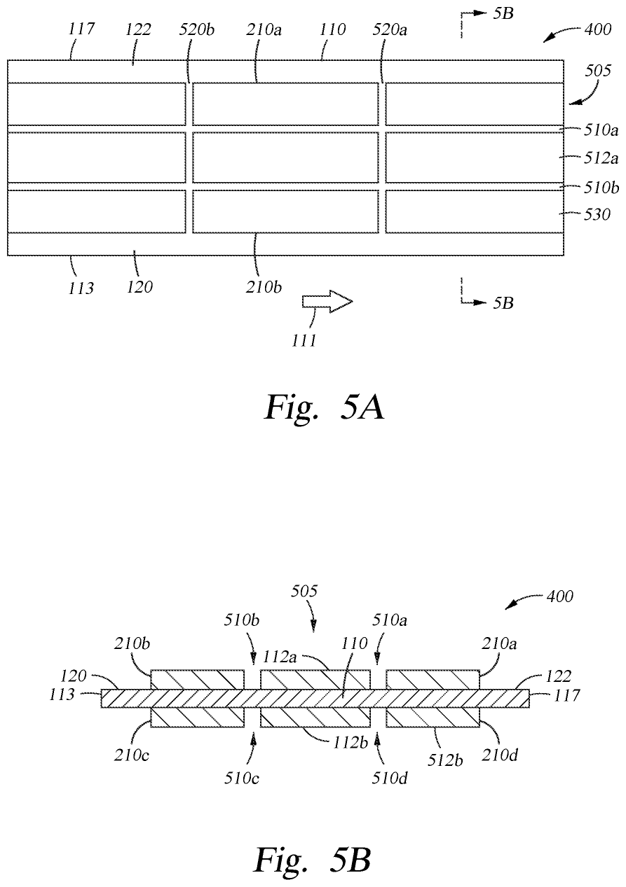

FIG. 5A illustrates a top plan view of the flexible layer stack 400 of FIG. 4A after laser patterning in accordance with one or more embodiments of the present disclosure. FIG. 5B illustrates a cross-sectional side view of the flexible layer stack 400 of FIG. 5A in accordance with one or more embodiments of the present disclosure. The flexible layer stack 400 depicted in FIGS. 5A and 5B, has a plurality of trenches 505 formed through the lithium film stack 112 to form a patterned film layer stack 512a, 512b (collectively 512) and divide the flexible layer stack 400 into patterned cells 530. The trenches 505 can include trenches 510a-510d (collectively 510) perpendicular to the width “W2” (e.g., parallel to the travel direction shown by arrow 111) of the flexible conductive substrate 110. The trenches 505 can further includes trenches 520a, 520b (collectively 520) parallel to the width “W2” (e.g., perpendicular to the travel direction shown by arrow 111) of the flexible conductive substrate 110. The plurality of trenches 505 can have a depth that exposes the flexible conductive substrate 110 underlying the patterned film stack 512.

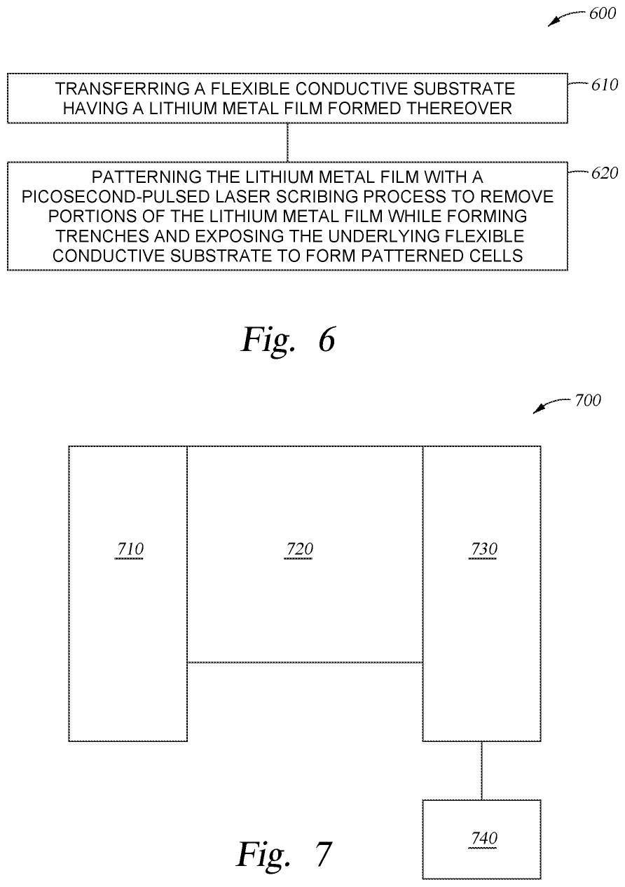

FIG. 6 illustrates a flow diagram of a processing sequence 600 of laser patterning in accordance with one or more embodiments of the present disclosure. The processing sequence 600 can be used to laser pattern a lithium film stack, for example, the lithium film stack 112 on the flexible conductive substrate 110 shown in FIGS. 4A-4B. The processing sequence 600 can be performed using a laser patterning chamber, for example, the laser patterning chamber 720 depicted in FIG. 7. The laser patterning chamber 720 can be positioned in a coating system, such as the roll-to-roll web coating system 700 depicted in FIG. 7.

At operation 610, a flexible conductive substrate having a lithium metal film stack formed thereover is transferred. In one or more embodiments which can be combined with other embodiments, transferring the flexible conductive substrate comprises moving the flexible conductive substrate at a speed from about 0.1 meters/minute to about 50 meters/minute.

At operation 620 during transfer of the flexible conductive substrate 110 the lithium metal film stack is patterned with a picosecond-pulsed laser scribing process to form trenches in the lithium film stack. The picosecond-pulsed laser scribing process removes portions of the lithium film stack to form trenches and pattern the lithium film stack. The trenches can expose a surface of the flexible conductive substrate underlying the lithium film stack. The trenches can be formed parallel to and/or perpendicular to a width of the flexible conductive substrate.

A single process tool can be configured to perform many or all of the operations in a picosecond-based laser ablation edge cleaning and/or laser patterning process as described herein. For example, FIG. 7 illustrates a schematic view of a roll-to-roll web coating system 700 for picosecond-based laser ablation edge cleaning and/or laser patterning in accordance with one or more embodiments of the present disclosure. The roll-to-roll web coating system 700 can be used to produce energy storage devices, for example, lithium-ion batteries.

Referring to FIG. 7, the roll-to-roll web coating system 700 includes a first processing chamber 710, a second processing chamber 730, and a laser patterning chamber 720 coupling the first processing chamber 710 with the second processing chamber 730. In one or more embodiments which can be combined with other embodiments, the first processing chamber 710, the laser patterning chamber 720, and the second processing chamber 730 can share a common processing environment. In one or more examples, the common processing environment is operable as a vacuum environment. In other examples, the common processing environment is operable as an inert gas environment. In some embodiments which can be combined with other embodiments, the first processing chamber 710, the laser patterning chamber 720, and the second processing chamber 730 have a separate processing environment

The first processing chamber 710 can be configured to deposit a lithium metal film over a web substrate in a roll-to-roll process. In one or more embodiments which can be combined with other embodiments, the first processing chamber 710 is configured to lithiate or pre-lithiate an anode material formed on the web substrate by depositing a layer of lithium metal on the anode material. In some embodiments which can be combined with other embodiments, the first processing chamber 710 is configured to form a lithium metal anode on or over the web substrate. The first processing chamber 710 can include one or more deposition sources. The one or more deposition sources can be configured to deposit a lithium metal film. Examples of suitable deposition sources include, but are not limited to, thermal evaporation sources, e-beam evaporation sources, PVD sputtering sources, CVD coating sources, slot-die coating sources, kiss roller coating sources, Meyer bar coating sources, gravure roller coating sources, or any combination thereof.

The second processing chamber 730 can be configured to deposit additional films over the patterned lithium metal film(s) in the roll-to-roll process. In one or more embodiments which can be combined with other embodiments, the additional film is a protective film. Examples of materials that may be used to form the protective film include, but are not limited to, lithium fluoride (LiF), aluminum oxide, lithium carbonate (Li₂CO₃), lithium-ion conducting materials, or a combination thereof. The second processing chamber 730 can include one or more deposition sources. Examples of suitable deposition sources include, but are not limited to, PVD sources, such as evaporation or sputtering sources, atomic layer deposition (ALD) sources, CVD sources, slot-die sources, a thin-film transfer sources, or a three-dimensional printing sources.

The laser patterning chamber 720 houses one or more picosecond-based lasers. The one or more picosecond-based lasers are suitable for performing a laser ablation process, such as the laser ablation processes described herein. In one or more embodiments which can be combined with other embodiments, the picosecond-based laser is also moveable. In some embodiments which can be combined with other embodiments, the picosecond-based laser is fixed.

The roll-to-roll web coating system 700 can include other chambers suitable for processing the flexible conductive substrate. In one or more embodiments which can be combined with other embodiments, additional chambers can provide for deposition of an electrolyte soluble binder or the additional chambers can provide for formation of electrode material (positive or negative electrode material). In one or more embodiments which can be combined with other embodiments, additional chambers provide for cutting of the electrode. In one or more embodiments which can be combined with other embodiments, a wet/dry station is included. The wet/dry station may be suitable for cleaning residues and fragments, or for removing a mask, subsequent to laser patterning of the web. In one or more embodiments which can be combined with other embodiments, a metrology station is included as a component of the roll-to-roll web coating system 700.

The roll-to-roll web coating system 700 further includes a system controller 740 operable to control various aspects of the roll-to-roll web coating system 700. The system controller 740 facilitates the control and automation of the roll-to-roll web coating system 700 and can include a central processing unit (CPU), memory, and support circuits (or I/O). Software instructions and data can be coded and stored within the memory for instructing the CPU. The system controller 740 can communicate with one or more of the components of the roll-to-roll web coating system 700 via, for example, a system bus. A program (or computer instructions) readable by the system controller 740 determines which tasks are performable on a substrate. In some aspects, the program is software readable by the system controller 740, which can include code to control processing of the web substrate. Although shown as a single system controller 740, it should be appreciated that multiple system controllers can be used with the aspects described herein.

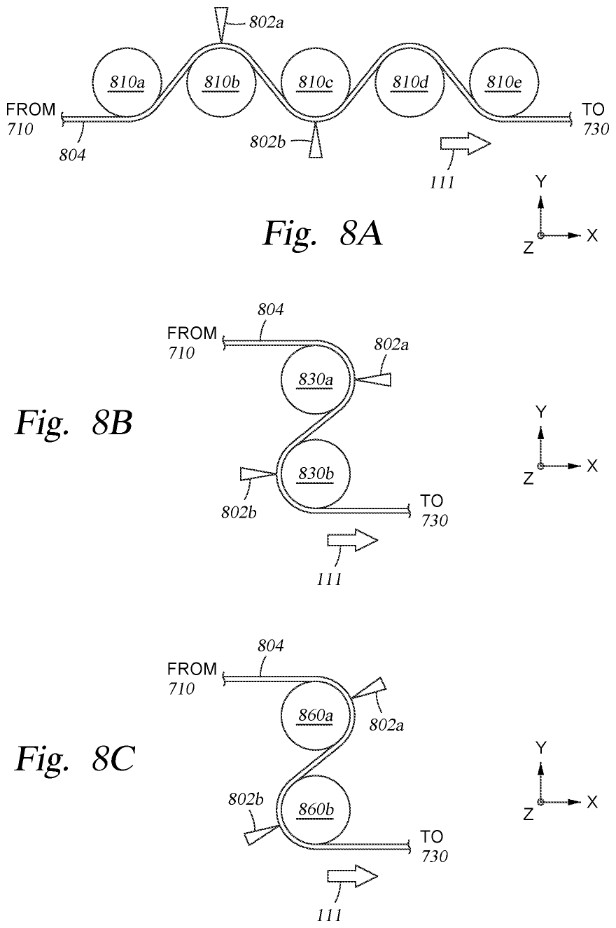

FIG. 8A illustrates a schematic side view of a laser source arrangement 800 in accordance with one or more embodiments of the present disclosure. The laser source arrangement 800 can be used in a laser patterning chamber, for example, the laser patterning chamber 720. The laser source arrangement 800 includes a pair of laser sources 802a, 802b (collectively 802) each positioned to pattern opposing sides of a flexible layer stack 804. The flexible layer stack 804 can be similar to the flexible layer stack 100 or the flexible layer stack 400 described above. The laser source arrangement 800 further includes a plurality of transfer rollers 810a-810e (collectively 810) for transporting the flexible layer stack 804. Although five transfer rollers 810a-810e are shown, any suitable number of transfer rollers 810 can be used. The laser source 802a is positioned above the plurality of transfer rollers 810 and the laser source 802b is positioned below the plurality of transfer rollers 810. The laser sources 802 can be positioned to emit a laser beam that is perpendicular to the travel direction shown by arrow 111 of the flexible layer stack 804.

FIG. 8B illustrates a schematic side view of another laser source arrangement 820 in accordance with one or more embodiments of the present disclosure. The laser source arrangement 820 can be used in a laser patterning chamber, for example, the laser patterning chamber 720. The laser source arrangement 820 includes the pair of laser sources 802a, 802b (collectively 802) each positioned to pattern opposing sides of the flexible layer stack 804. The laser source arrangement 820 further includes a plurality of transfer rollers 830a-830b (collectively 830) for transporting the flexible layer stack 804. The transfer roller 830a is positioned above the transfer roller 830b. The laser source 802a is positioned adjacent to the transfer roller 810a to process a first side of the flexible layer stack 804 while the flexible layer stack 804 travels over a surface of the transfer roller 830a. The laser source 802b can be positioned adjacent to the transfer roller 830b to process a second side of the flexible layer stack 804 while the flexible layer stack 804 travels over a surface of the transfer roller 830b. The laser sources 802 can be positioned to emit a laser beam that is parallel to the travel direction shown by arrow 111 of the flexible layer stack 804.

FIG. 8C illustrates a schematic side view of yet another laser source arrangement 850 in accordance with one or more embodiments of the present disclosure. The laser source arrangement 850 can be used in a laser patterning chamber, for example, the laser patterning chamber 720. The laser source arrangement 850 includes the pair of laser sources 802a, 802b (collectively 802) each positioned to pattern opposing sides of the flexible layer stack 804. The laser source arrangement 850 further includes a plurality of transfer rollers 860a-860b (collectively 860) for transporting the flexible layer stack 804. The transfer roller 860a is positioned above the transfer roller 860b. The laser source 802a is positioned adjacent to the transfer roller 810a to process a first side of the flexible layer stack 804 while the flexible layer stack 804 travels over a surface of the transfer roller 860a. The laser source 802b can be positioned adjacent to the transfer roller 860b to process a second side of the flexible layer stack 804 while the flexible layer stack 804 travels over a surface of the transfer roller 860b. The laser sources 802 can be positioned to emit a laser beam that is positioned or otherwise angled relative to the travel direction shown by arrow 111 of the flexible layer stack 804.

To avoid degradation of lithium due to its interaction with moisture or other sensitive gases, the laser source arrangements 800, 820, and 850 can be operated in a dry room with very low humidity or in a vacuum environment. Laser ablated debris can be removed simultaneously from the processing site by flowing an inert gas, for example, argon, to remove the debris.

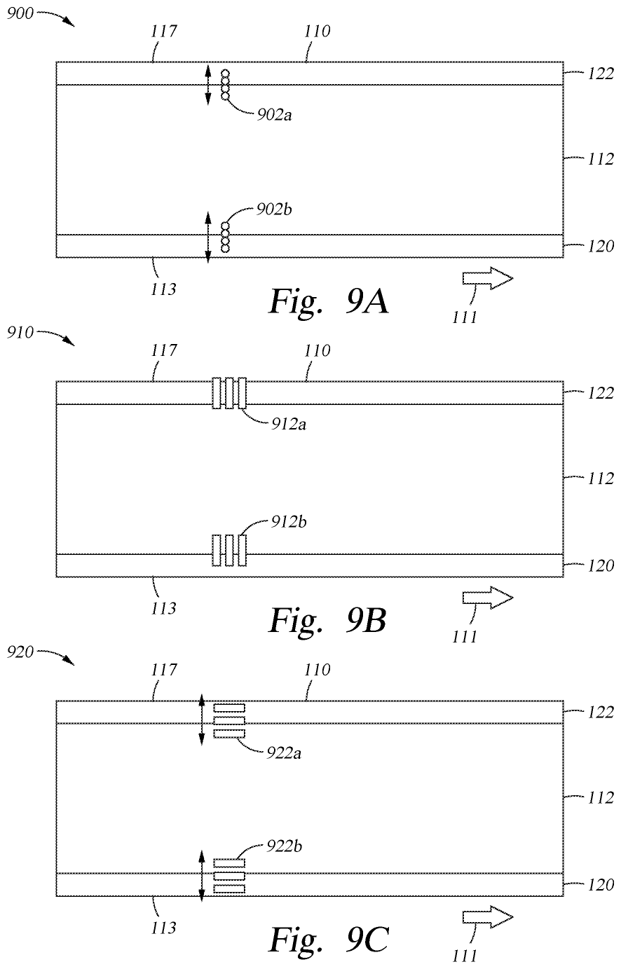

FIG. 9A illustrates a schematic top view of one laser configuration 900 for laser edge cleaning in accordance with one or more embodiments of the present disclosure. In the laser configuration 900 a circular Gaussian spot 902b is formed along the near edge 113 and a circular Gaussian spot 902a (collectively 902) is formed along the far edge 117. The circular Gaussian spots 902 can be formed through a 2-axis galvo scanner or polygon scanner system onto the web edge to perform laser ablation.

FIG. 9B illustrates a schematic top view of another laser configuration 910 for laser edge cleaning in accordance with one or more embodiments of the present disclosure. In the laser configuration 910 a line-shaped spot 912b is formed along the near edge 113 perpendicular to the near edge 113 (perpendicular to the travel direction shown by arrow 111) and a line-shaped spot 912a (collectively 912) is formed along the far edge 117 perpendicular to the far edge 117 (perpendicular to the travel direction shown by arrow 111). The line-shaped spots 912 can be formed through a fixed laser onto the web edge to perform laser ablation.

FIG. 9C illustrates a schematic top view of yet another laser configuration 920 for laser edge cleaning in accordance with one or more embodiments of the present disclosure. In the laser configuration 920 a line-shaped spot 922b is formed along the near edge 113 parallel to the near edge 113 (parallel to the travel direction shown by arrow 111) and a line-shaped spot 922a (collectively 922) is formed along the far edge 117 parallel to the far edge 117 (parallel to the travel direction shown by arrow 111). The line-shaped spots 922 can be formed through a single-axis galvo scanner or polygon scanner system onto the web edge to perform laser ablation.

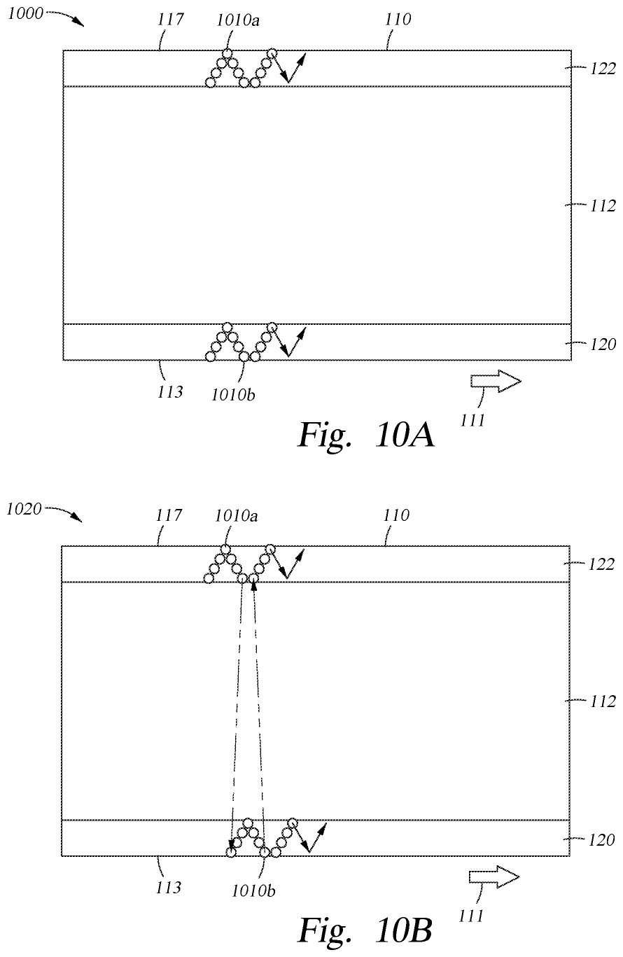

FIG. 10A illustrates a schematic top view of one laser configuration 1000 for laser edge cleaning in accordance with one or more embodiments of the present disclosure. FIG. 10B illustrates a schematic top view of another laser configuration 1020 for laser edge cleaning in accordance with one or more embodiments of the present disclosure. In the laser configuration 1000 each laser beam is focused into a circular Gaussian spot 1010a, 1010b (collectively 1010) through a galvo scanner or polygon scanner system onto the web edge to perform laser ablation. While the web is moving at a set speed, the galvo or polygon scanner quickly scans the laser beam perpendicular to the travel direction shown by arrow 111 of the web. The repetitive back-and forth laser scanning normal to the travel direction of the web can cause a gap between two opposite scanning lines. To eliminate the gap, a Zigzag scanning pattern can be used to compensate for web movement, as shown on right. In the case of using galvo scanners, each edge can be served by one dedicated laser beam as shown in the laser configuration 1000 or is a split beam from the same laser as shown in the laser configuration 1020.

In one or more embodiments which can be combined with other embodiments, the moving speed can be set according to a diameter of the laser spot and the laser process parameters can be optimized for acceptable line-to-line hatching distance.

In one or more embodiments which can be combined with other embodiments, the laser beam has a beam quality of M² value in the range of 1.5 to 3.5. This M² value in the range of 1.5 to 3.5 provides a more uniform pulse density distribution in a spot compared to a Gaussian spot, which typically has a M² value in the range of 1 to 1.3.

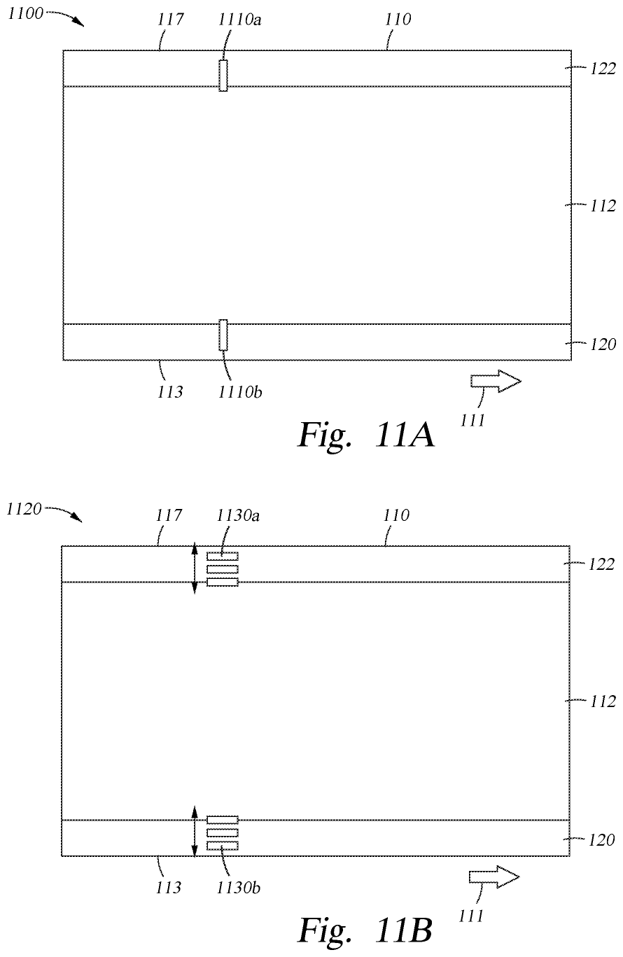

FIG. 11A illustrates a schematic top view of one laser configuration 1100 for laser edge cleaning in accordance with one or more embodiments of the present disclosure. In the laser configuration 1100, each laser beam is focused into a line-shaped profile 1110a, 1110b (collectively 1110) (e.g., a 10 mm long, 50 μm wide line-shaped beam) through a set of stationary optics onto the web edge to do laser ablation. The optics is set up in such a way that the focused line-shaped beam 1110 is on a fixed position while web is moving along the travel direction shown by arrow 111 at a set speed. Each edge is served by a dedicated laser beam either from one laser source or is a split beam from a single laser. The web moving speed can be set according to the width of the line-shaped beam and optimized laser process parameters for acceptable line-to-line hatching distance. It is noted that compared to a Gaussian spot, a line-shaped beam has ˜30% higher laser energy utilization efficiency.

FIG. 11B illustrates a schematic top view of another laser configuration 1120 for laser edge cleaning in accordance with one or more embodiments of the present disclosure. In the laser configuration 1120, each laser beam is focused into a line-shaped spots 1130a, 1130b (collectively 1130) (e.g., a line-shaped beam with a length of about 10 mm and a width of about 50 μm) through a set of stationary optics and galvo scanner optics onto the web edge to do laser ablation. The optics is set up in such a way that the focused line-shaped beam has a length direction that is parallel to the travel direction shown by arrow 111 of the web. While the web is moving, a galvo scanning laser beam normal to the travel direction shown by arrow 111 can be utilized for edge cleaning. This takes advantage of multi-pass ablation, which produces improved edge cleaning. Each edge is served by a dedicated laser beam either from one laser source or is a split beam from a single laser. The web moving speed can be set according to the width of the line-shaped beam and optimized laser process parameters for acceptable line-to-line hatching distance. Each line-shaped spot in either the line-shaped spots 1130a or the line-shaped spots 1130b can overlap with line-shapes spots in the same group.

Embodiments can include one or more of the following potential advantages. Efficiently removing lithium and exposing underlying copper for either edge cleaning or web dividing/patterning presents without damaging the underlying copper substrate or web. Moreover, any deformation or distortion of the underlying copper substrate is minimal. The edge cleaning process achieve a high level of cleanliness (e.g., a low level of lithium residue in the patterned areas). In addition, the cleaning process can be matched with the high speed of the moving web substrate.

Embodiments and all of the functional operations described in this specification can be implemented in digital electronic circuitry, or in computer software, firmware, or hardware, including the structural means disclosed in this specification and structural equivalents thereof, or in combinations of them. Embodiments described herein can be implemented as one or more non-transitory computer program products, e.g., one or more computer programs tangibly embodied in a machine readable storage device, for execution by, or to control the operation of, data processing apparatus, e.g., a programmable processor, a computer, or multiple processors or computers.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. Processors suitable for the execution of a computer program include, by way of example, both general and special purpose microprocessors, and any one or more processors of any kind of digital computer.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

When introducing elements of the present disclosure or exemplary aspects or embodiment(s) thereof, the articles “a,” “an,” “the” and “said” are intended to mean that there are one or more of the elements.

Embodiments of the present disclosure further relate to any one or more of the following examples 1-22.

1. A method of producing an energy storage device, comprising: transferring a flexible conductive substrate having a lithium metal film formed thereover; and patterning the lithium metal film with a picosecond-pulsed laser scribing process to remove portions of the lithium metal film exposing the underlying flexible conductive substrate without etching the flexible conductive substrate while transferring the flexible conductive substrate.

2. The method according to example 1, wherein patterning the lithium metal film with a picosecond-pulsed laser scribing process to remove portions of the lithium metal film exposing the underlying flexible conductive substrate comprises forming trenches parallel to and perpendicular to a width of the flexible conductive substrate to form patterned cells.

3. The method according to example 1 or 2, wherein patterning the lithium metal film with a picosecond-pulsed laser scribing process to remove portions of the lithium metal film exposing the underlying flexible conductive substrate comprises removing lithium from a transition region adjacent to an edge of the flexible conductive substrate.

4. The method according to any one of examples 1-3, wherein patterning the lithium metal film with a picosecond-pulsed laser scribing process comprises using a pulsed infrared laser having a wavelength of about 1 micrometer with a laser pulse width of about 15 nanoseconds or less and a pulse rep rate frequency of about 100 kHz or greater.

5. The method according to example 4, wherein the laser pulse width is from about 1 picosecond to about 15 picoseconds and the pulse rep rate frequency is 50 MHz or greater.

6. The method according to any one of examples 1-5, wherein transferring the flexible conductive substrate comprises moving the flexible conductive substrate at a speed from about 0.1 meters/minute to about 50 meters/minute.

7. The method according to any one of examples 1-6, wherein patterning the lithium metal film with the picosecond-pulsed laser scribing process comprises a single-pass laser ablation process.

8. The method according to any one of examples 1-7, wherein the picosecond-pulsed laser produces a line-shaped laser beam.

9. The method according to example 8, wherein the line-shaped laser beam is produced by single axis galvo scanning or polygon scanning.

10. The method according to any one of examples 1-9, wherein the picosecond-pulsed laser produces a circular Gaussian laser spot produced by 2-axis galvo scanning or polygon scanning.

11. A laser patterning system for patterning an energy storage device, comprising: a laser patterning chamber defining a processing volume and for processing a flexible conductive substrate having a film stack formed thereon; a plurality of transfer rollers positioned in the processing volume and for transferring the flexible conductive substrate; and a laser source arrangement comprising one or more picosecond-pulsed lasers positioned to expose the film stack to a laser as the flexible conductive substrate is in contact with at least one of the transfer rollers.

12. The laser patterning system according to example 11, wherein the laser source arrangement comprises a first laser source positioned above the plurality of transfer rollers to process a first side of the flexible conductive substrate and a second laser source positioned below the plurality of transfer rollers to process a second side of the flexible conductive substrate.

13. The laser patterning system according to example 12, wherein at least one of the first laser source and the second laser source is positioned to emit a laser beam that is perpendicular to a travel direction of the flexible conductive substrate.

14. The laser patterning system according to any one of examples 11-13, wherein the plurality of transfer rollers comprises a first transfer roller positioned above a second transfer roller and the laser source arrangement comprises a first laser source positioned to process a first side of the flexible conductive substrate and a second laser source positioned process a second side of the flexible conductive substrate.

15. The laser patterning system according to any one of examples 11-14, wherein at least one of the first laser source and the second laser source is positioned to emit a laser beam that is parallel to a travel direction of the flexible conductive substrate.

16. The laser patterning system according to any one of examples 11-15, wherein the one or more picosecond-pulsed lasers are positioned to remove lithium from a transition region adjacent to an edge of the flexible conductive substrate.

17. The laser patterning system according to any one of examples 11-16, wherein the one or more picosecond-pulsed lasers are positioned to form trenches parallel to and perpendicular to a width of the flexible conductive substrate to form patterned cells.

18. The laser patterning system according to any one of examples 11-17, wherein the one or more picosecond-pulsed lasers produce a pulsed infrared laser having a wavelength of about 1 micrometer with a laser pulse width of about 15 nanoseconds or less and a pulse rep rate frequency of about 100 kHz or greater.

19. The laser patterning system according to example 18, wherein the laser pulse width is from about 1 picosecond to about 15 picoseconds and the pulse rep rate frequency is 50 MHz or greater.

20. The laser patterning system according to any one of examples 11-19, wherein the picosecond-pulsed laser produces a line-shaped laser beam.

21. The laser patterning system according to example 20, wherein the line-shaped laser beam is produced by single axis galvo scanning or polygon scanning.

22. The laser patterning system according to any one of examples 11-21, wherein the picosecond-pulsed laser produces a circular Gaussian laser spot produced by 2-axis galvo scanning or polygon scanning.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the terms “including” and “having” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated. As used herein, the term “about” refers to a +/−10% variation from the nominal value. It is to be understood that such a variation can be included in any value provided herein.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

1. A method of producing an energy storage device, comprising:
transferring a flexible conductive substrate having a lithium metal film formed thereover; and
patterning the lithium metal film with a picosecond-pulsed laser scribing process to remove portions of the lithium metal film exposing the underlying flexible conductive substrate without etching the flexible conductive substrate while transferring the flexible conductive substrate.

2. The method of claim 1, wherein patterning the lithium metal film with a picosecond-pulsed laser scribing process to remove portions of the lithium metal film exposing the underlying flexible conductive substrate comprises forming trenches parallel to and perpendicular to a width of the flexible conductive substrate to form patterned cells.

3. The method of claim 1, wherein patterning the lithium metal film with a picosecond-pulsed laser scribing process to remove portions of the lithium metal film exposing the underlying flexible conductive substrate comprises removing lithium from a transition region adjacent to an edge of the flexible conductive substrate.

4. The method of claim 1, wherein patterning the lithium metal film with a picosecond-pulsed laser scribing process comprises using a pulsed infrared laser having a wavelength of about 1 micrometer with a laser pulse width of about 15 nanoseconds or less and a pulse rep rate frequency of about 100 kHz or greater.

5. The method of claim 4, wherein the laser pulse width is from about 1 picosecond to about 15 picoseconds and the pulse rep rate frequency is 50 MHz or greater.

6. The method of claim 1, wherein transferring the flexible conductive substrate comprises moving the flexible conductive substrate at a speed from about 0.1 meters/minute to about 50 meters/minute.

7. The method of claim 1, wherein patterning the lithium metal film with the picosecond-pulsed laser scribing process comprises a single-pass laser ablation process.

8. The method of claim 1, wherein the picosecond-pulsed laser produces a line-shaped laser beam.

9. The method of claim 8, wherein the line-shaped laser beam is produced by single axis galvo scanning or polygon scanning.

10. The method of claim 1, wherein the picosecond-pulsed laser produces a circular Gaussian laser spot produced by 2-axis galvo scanning or polygon scanning.

11. A laser patterning system for patterning an energy storage device, comprising:
a laser patterning chamber defining a processing volume and for processing a flexible conductive substrate having a film stack formed thereon;
a plurality of transfer rollers positioned in the processing volume and for transferring the flexible conductive substrate; and
a laser source arrangement comprising one or more picosecond-pulsed lasers positioned to expose the film stack to a laser as the flexible conductive substrate is in contact with at least one of the transfer rollers.

12. The laser patterning system of claim 11, wherein the laser source arrangement comprises a first laser source positioned above the plurality of transfer rollers to process a first side of the flexible conductive substrate and a second laser source positioned below the plurality of transfer rollers to process a second side of the flexible conductive substrate.

13. The laser patterning system of claim 12, wherein at least one of the first laser source and the second laser source is positioned to emit a laser beam that is perpendicular to a travel direction of the flexible conductive substrate.

14. The laser patterning system of claim 12, wherein at least one of the first laser source and the second laser source is positioned to emit a laser beam that is parallel to a travel direction of the flexible conductive substrate.

15. The laser patterning system of claim 11, wherein the plurality of transfer rollers comprises a first transfer roller positioned above a second transfer roller and the laser source arrangement comprises a first laser source positioned to process a first side of the flexible conductive substrate and a second laser source positioned process a second side of the flexible conductive substrate.

16. The laser patterning system of claim 11, wherein the one or more picosecond-pulsed lasers are positioned to remove lithium from a transition region adjacent to an edge of the flexible conductive substrate.

17. The laser patterning system of claim 11, wherein the one or more picosecond-pulsed lasers are positioned to form trenches parallel to and perpendicular to a width of the flexible conductive substrate to form patterned cells.

18. The laser patterning system of claim 11, wherein the one or more picosecond-pulsed lasers produce a pulsed infrared laser having a wavelength of about 1 micrometer with a laser pulse width of about 15 nanoseconds or less and a pulse rep rate frequency of about 100 kHz or greater.

19. The laser patterning system of claim 11, wherein the picosecond-pulsed laser produces a line-shaped laser beam, and wherein the line-shaped laser beam is produced by single axis galvo scanning or polygon scanning.

20. A laser patterning system for patterning an energy storage device, comprising:
a laser patterning chamber defining a processing volume and for processing a flexible conductive substrate having a film stack formed thereon;
a plurality of transfer rollers positioned in the processing volume and for transferring the flexible conductive substrate; and
a laser source arrangement comprising:
one or more picosecond-pulsed lasers positioned to expose the film stack to a laser as the flexible conductive substrate is in contact with at least one of the transfer rollers; and
a first laser source positioned above the plurality of transfer rollers to process a first side of the flexible conductive substrate and a second laser source positioned below the plurality of transfer rollers to process a second side of the flexible conductive substrate, wherein at least one of the first laser source and the second laser source is positioned to emit a laser beam that is perpendicular or parallel to a travel direction of the flexible conductive substrate, and wherein the one or more picosecond-pulsed lasers produce a pulsed infrared laser having a wavelength of about 1 micrometer with a laser pulse width of about 15 nanoseconds or less and a pulse rep rate frequency of about 100 kHz or greater.
